(19) United States
(12) Patent Application Publication
(10) Pub. No.: US 2002/0136094 A1
(43) Pub. Date: Sep. 26, 2002

(54) TIME OUTPUT APPARATUS AND TIME CORRECTION METHOD

(76) Inventor: EIJI KAWAI, TOKYO (JP)

Correspondence Address: KATTEN MUCHIN ZAVIS ROSENMAN, 575 MADISON AVENUE, NEW YORK, NY, 10022-2585, US

(21) Appl. No.: 09/384,782

(22) Filed: Aug. 27, 1999

(30) Foreign Application Priority Data
Aug. 31, 1998 (JP) P10-245929

(51) Int. Cl. G04C 11/02

(52) U.S. Cl. 368/47

(57) ABSTRACT

An automatic time difference correction apparatus includes an RTC (Real Time Clock) circuit which outputs standard time information that indicates an absolute standard time, a time difference table 3 which holds time difference information that indicates the time difference between the absolute standard time and the time at a certain position corresponding to positional information that indicates that position, a GPS (Global Positioning System) decoder which acquires current-position information that indicates the current position, a GPS receiver an antenna, a comparator which obtains time difference information corresponding to the current position by comparing the positional information and the current-position information, and a computing element which calculates the time at the current position based on the time difference information corresponding to the current position and the standard time information.

### FIELD OF THE INVENTION

The present invention relates to a time output apparatus that displays or otherwise provides output of time information, and a time correction method that corrects the time.

### BACKGROUND OF THE INVENTION

A wristwatch is a representative example of portable electronic equipment that tells time. Other equipment that tells time includes portable audio equipment provided with time-indicating functions and the so-called notebook computers.

For example, a traveler may take such portable electronic equipment and move to a region where there is a time difference. In such a case, the traveler must manually correct the time of the portable electronic equipment. In addition, there are also types of equipment that are preset to the standard time of major regions throughout the world, and in this case, the traveler must manually select the time matching the place one has reached.

However, when the time of a piece of portable electronic equipment is manually corrected or selected, there is the possibility of mistakes occurring. In addition, in the case of manual correction, time passes while the correction is being performed, so there are cases in which errors of several seconds occur. Moreover, since the timing of correction is not a first consideration, cases in which the correction is done too late or one forgets to make the correction can occur often, so this is a problem.

In addition, when the time is to be corrected for summer time (daylight-saving time), the rules for this differ depending on the region, so when this is performed manually, there are the same problems as described above, and also it may take time, among other problems.

Thus, for a traveler who often moves among various regions, accurately correcting for both time differences and daylight-saving time can be quite worrisome.

### SUMMARY OF THE INVENTION

It is an object of the present invention to provide a time output apparatus and a time correction method that are able to accurately correct the time at the destination of a move without manually correcting the time.

In order to solve the aforementioned problems and attain at the above object the time output apparatus according to the present invention comprises: a standard time output means that outputs standard time information that indicates an absolute standard time, a holding means which holds time difference information that indicates the time difference between the absolute standard time and the time at a certain position corresponding to positional information that indicates that position, a current-position acquisition means that acquires current-position information that indicates the current position, a comparison means that obtains time difference information corresponding to the current position by comparing the positional information and the current-position information, and a calculation means that calculates the time at the current position based on the time difference information corresponding to the current position and the standard time information.

In a time output apparatus of the present invention, the comparison means compares the current-position information that indicates the current position obtained by the current-position acquisition means against the positional information in the holding means which holds time difference information that indicates the time difference between the absolute standard time and the time at that position, and thus obtains the time difference information corresponding to the current position. Then, in the time output apparatus, the calculation means calculates the time at the current position based on the time difference information corresponding to this current position and the standard time information that indicates the absolute standard time information.

Thereby, the time output apparatus is corrected to the time at the current position.

In addition, in order to solve the aforementioned problems, a time correction method according to the present invention comprises: a current-position acquisition step wherein current-position information that indicates the current position is acquired, a comparison step wherein the current-position information that indicates the current position obtained by the current-position acquisition means is compared against the positional information of the holding means which holds time difference information that indicates the time difference between the absolute standard time and the time at that position and thus the time difference information corresponding to the current position is obtained, and a calculation step wherein the time at the current position is calculated based on the time difference corresponding to the current position and the standard time information that indicates the absolute standard time information.

Thereby, the time output apparatus is corrected to the time at the current position.

### BRIEF DESCRIPTION OF THE DRAWINGS

FIG. 1 is a block diagram showing the structure of an automatic time difference correction apparatus which is an embodiment of the present invention; and

FIG. 2 is a flowchart showing the processing of the automatic time difference correction apparatus until the time at the current position is corrected.

### DETAILED DESCRIPTION OF THE INVENTION

Here follows a detailed explanation of a mode of working the present invention made with reference to the appended drawings. This mode of working applies the time output apparatus and time correction method according to the present invention to an automatic time difference correction apparatus equipped with a time display apparatus.

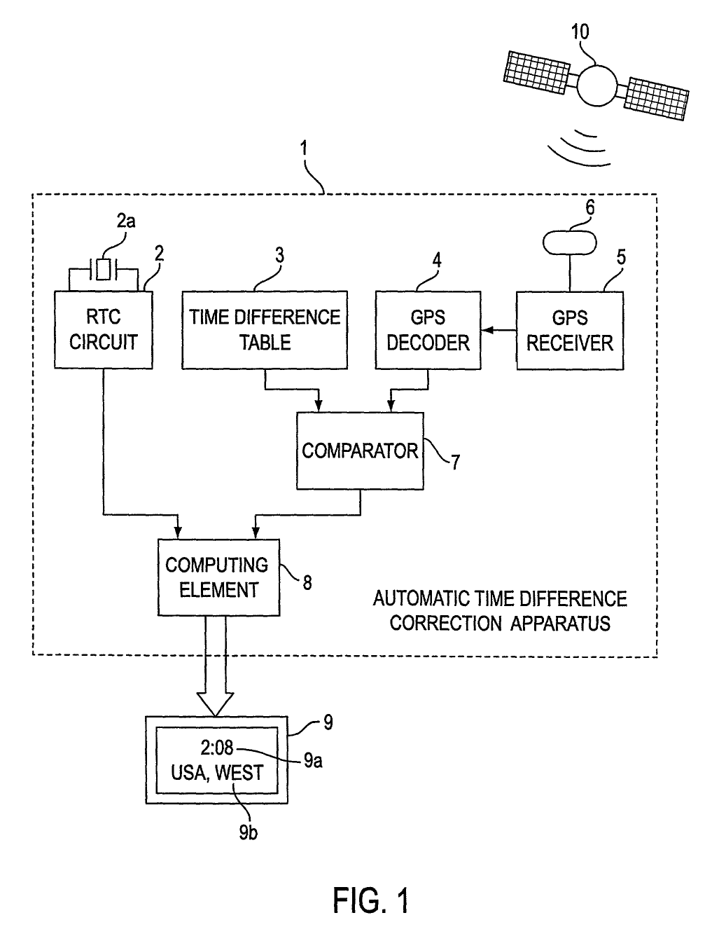

As shown in FIG. 1, the automatic time difference correction apparatus consists of an RTC (Real Time Clock) circuit 2 which is a standard time output means that outputs standard time information that indicates an absolute standard time, a time difference table 3 which is a holding means which holds time difference information that indicates the time difference between the absolute standard time and the time at a certain position corresponding to positional information that indicates that position, a GPS (Global Positioning System) decoder 4 which is a current-position acquisition means that acquires current-position information that indicates the current position, a GPS receiver 5 and an antenna 6, a comparator 7 which is a comparison means that obtains time difference information corresponding to the current position by comparing the positional information and the current-position information, and a computing element 8 which is a calculation means that calculates the time at the current position based on the time difference information corresponding to the current position and the standard time information. Moreover, the automatic time difference correction apparatus 1 is equipped with a display apparatus 9 for displaying the time at the current position calculated by means of the computing element 8.

Note that the automatic time difference correction apparatus 1 may be equipped with a CPU (not shown) as a control system means for controlling the various components within said automatic time difference correction apparatus 1.

In this automatic time difference correction apparatus 1, the aforementioned current-position acquisition means receives satellite-transmitted radio signals from a GPS satellite 10 and measures the current position.

Here follows a detailed description of the aforementioned various components of the automatic time difference correction apparatus 1.

The GPS receiver 5 consists of components that process the GPS signals sent from the aforementioned GPS satellite 10 and received by the antenna 6. For example, the GPS signals are subjected to frequency spreading using pseudo-noise known as the PN code, so the GPS receiver 5 compares the PN code phase against the PN code sent from the GPS satellite 10 and thus performs tracking and other operations.

The GPS decoder 4 provides an output of positioning data based on the data obtained from the aforementioned GPS receiver 5. The positioning data is data consisting of current-position information that indicates the current position where that automatic time difference correction apparatus 1 is currently positioned.

The GPS decoder 4, GPS receiver 5 and antenna 6 thus constitute a current-position acquisition means for acquiring this positioning data.

The time difference table 3 consists of a table of various data. Specifically, it contains a so-called time-difference conversion table in which is recorded time difference information that indicates the time difference between the absolute standard time and the time at a certain position corresponding to positional information that indicates that position. This time-difference conversion table consists of conversion data for converting time differences around the world, and specifically holds longitude and latitude as positional information and also holds the aforementioned time difference information obtained with respect to the aforementioned absolute standard time corresponding to that longitude and latitude.

In the event that the positional information indicates a longitude and latitude within the country of Japan for example, this time-difference conversion table contains time difference information for Akashi Standard Time (Japan Standard Time) at 135° east longitude for the aforementioned absolute standard time. Alternately, in the event that the positional information indicates a longitude and latitude within the country of the United States for example, it contains time difference information for one of Eastern time at 75° west longitude, Central time at 90° west longitude, Mountain time at 105° west longitude, Pacific time at 120° west longitude, Yukon time at 135° west longitude, Alaska time at 150° west longitude or Bering time at 165° west longitude, corresponding to that longitude and latitude.

Furthermore, the time difference table 3 also contains a so-called daylight-saving time conversion table in which is recorded the daylight-saving time information consisting of conversion data for converting time difference information in the aforementioned time-difference conversion table for use in daylight-saving time.

The automatic time difference correction apparatus 1 may hold the time difference table 3 as being recorded in ROM, for example.

The comparator 7 is constituted such that it compares the positional information and the positioning data to obtain the time difference information corresponding to the current position. To wit, based on the positioning data that indicates the current position, the comparator 7 acquires time difference information corresponding to this current position from the time-difference conversion table within the time difference table 3.

The RTC circuit 2 is constituted as a circuit that outputs an absolute standard time. This RTC circuit 2 is equipped with an oscillator 2a as a timing means.

This RTC circuit 2 is a circuit typically used for the output of time/calendar information and measures the current values of the year, month, date, hours, minutes and seconds using a special timer. The time output by this RTC circuit 2 is used as an absolute standard time. Note that the automatic time difference correction apparatus 1 can also use the CPU instead of this RTC circuit 2 and perform the measurement of the current values of the year, month, date, hours, minutes and seconds by having the CPU process a general-use timer in software.

The computing element 8 is constituted as a component that calculates the time at the current position based on the time difference information corresponding to the current position and the standard time information that indicates an absolute standard time. Specifically, this computing element 8 adds or subtracts the time difference corresponding to the current position obtained by the aforementioned comparator 7 to or from the standard time obtained by the aforementioned RTC circuit 2, and thus calculates the time at the current position of that automatic time difference correction apparatus 1.

In addition, in the event that the automatic time difference correction apparatus 1 determines that the region in which it is currently positioned is subject to daylight-saving time, it consults the aforementioned daylight-saving time conversion table and uses the conversion data to calculate the time for the current position corrected for daylight-saving time.

The display apparatus 9 is a display means for displaying the time 9a at the current position calculated by the aforementioned automatic time difference correction apparatus 1. Note that the automatic time difference correction apparatus 1 can also output the current-position information to the display apparatus 9, and in this case, the current position 9b is also displayed on the display apparatus 9.

Note that by equipping the automatic time difference correction apparatus 1 with a correction button for starting the process of correcting for time differences, it is possible to start the process of correcting for time differences on the signal of this correction button being pressed.

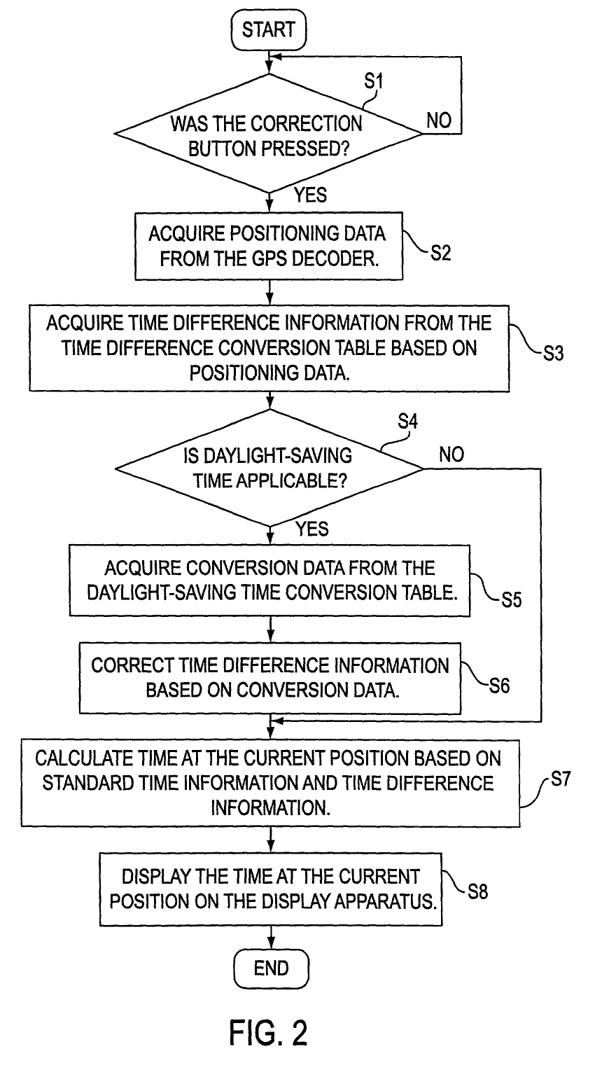

The automatic time difference correction apparatus 1 consisting of such various components calculates the time at the current position by means of the processing procedure shown in FIG. 2.

First, in Step S1, the automatic time difference correction apparatus 1 determines whether or not the correction button has been pressed, and if so, control proceeds to Step S2.

In Step S2, the automatic time difference correction apparatus 1 acquires from the GPS decoder 4 positioning data that indicates the current position. Using this positioning data, in the subsequent Step S3 the automatic time difference correction apparatus 1 acquires from the aforementioned time-difference conversion table the time difference information corresponding to that position.

Then, in Step S4, the automatic time difference correction apparatus 1 determines whether or not daylight-saving time applies to the region in which it is currently positioned. For example, the automatic time difference correction apparatus 1 may determine whether or not daylight-saving time applies based on the information on the current position that can be obtained from the positioning data.

The application of daylight-saving time is seasonal, namely it is applied for only a limited fixed time, so correspondingly, the determination of whether or not daylight-saving time applies can be made by verifying the month and date. However, this is not a limitation, as it is also possible for the user to use a selection button or the like to decide whether or not daylight-saving time applies, for example.

If the automatic time difference correction apparatus 1 determines that daylight-saving time applies, the automatic time difference correction apparatus 1 performs the processing of Step S5 and Step S6, but if it determines that daylight-saving time does not apply, control proceeds to Step S7.

In the Step S5, the automatic time difference correction apparatus 1 acquires conversion data from the aforementioned daylight-saving time conversion table. Then in Step S6, by means of the computing element 8, the automatic time difference correction apparatus 1 uses the conversion data to correct the aforementioned time difference information obtained from the aforementioned time-difference conversion table.

In Step S7, by means of the computing element 8, the automatic time difference correction apparatus 1 uses either the time difference information obtained in the aforementioned Step S3 or the time difference information corrected for daylight-saving time obtained in the aforementioned Step S5 and Step S6, along with the standard time information obtained from the RTC circuit 2 to calculate the time at the current position.

Then, the automatic time difference correction apparatus 1 displays on the display apparatus 9 the time at the current position thus obtained.

With an automatic time difference correction apparatus 1 constituted as above, it is able to output the time at the current position.

Thereby, the automatic time difference correction apparatus 1 is able to display a calendar/time that is automatically corrected for the time difference at any place on earth, and that is converted to daylight-saving time in regions where daylight-saving time applies. Thereby, a traveler can obtain accurate calendar/time information no matter where one is.

In addition, the automatic time difference correction apparatus 1 does not depend on manual operation, thereby eliminating problems such as when the correction is done too late or when one forgets to make the correction, along with mistakes and errors, and thereby it is possible to provide an extremely convenient calendar/time function.

For example, such an automatic time difference correction apparatus 1 can be applied to portable electronic equipment, and specifically, it can be applied to portable audio equipment and so-called notebook computers and the like.

In the explanation of the mode of working of the time output apparatus of the present invention, the time difference information acquired from the time difference conversion table is corrected by means of the daylight-saving time conversion table, but it is also possible to provide a separate time difference conversion table that is already calculated for daylight-saving time in advance, for example.

The time output apparatus according to the present invention comprises: a standard time output means that outputs standard time information that indicates an absolute standard time, a holding means which holds time difference information that indicates the time difference between the absolute standard time and the time at a certain position corresponding to positional information that indicates that position, a current-position acquisition means that acquires current-position information that indicates the current position, a comparison means that obtains time difference information corresponding to the current position by comparing the positional information and the current-position information, and a calculation means that calculates the time at the current position based on the aforementioned time difference information corresponding to the current position and the standard time information, and thereby, the comparison means compares the current-position information that indicates the current position obtained by the current-position acquisition means against the positional information of the holding means which holds time difference information that indicates the time difference between the absolute standard time and the time at that position, and thus obtains the time difference information corresponding to the current position and the calculation means calculates the time at the current position based on the time difference information corresponding to this current position and the standard time information that indicates the absolute standard time information.

Thereby, the time output apparatus is able to accurately correct for the time difference at the destination of a move without manually correcting the time.

In addition, the time correction method according to the present invention comprises a current-position acquisition step wherein current-position information that indicates the current position is acquired, a comparison step wherein the current-position information that indicates the current position obtained by the current-position acquisition means is compared against the positional information of the holding means which holds time difference information that indicates the time difference between the absolute standard time and the time at that position and thus the time difference information corresponding to the current position is obtained, and a calculation step wherein the time at the current position is calculated based on the time difference corresponding to the current position and the standard time information that indicates the absolute standard time information, and thereby, it is able to accurately correct for the time difference at the destination of a move without manually correcting the time.

What is claimed is:

1. A time output apparatus comprising:
a standard time output means that outputs standard time information that indicates an absolute standard time;
a holding means which holds time difference information that indicates the time difference between said absolute standard time and the time at a certain position corresponding to positional information that indicates said certain position,
a current-position acquisition means that acquires current-position information that indicates the current position;
a comparison means that obtains said time difference information corresponding to the current position by comparing said positional information and said current-position information; and
a calculation means that calculates the time at the current position based on the time difference information corresponding to said current position and said standard time information.

2. The time output apparatus recited in claim 1, wherein
said holding means stores said time difference information corresponding to said positional information as a data table in a storage means.

3. The time output apparatus recited in claim 1, wherein
said holding means holds daylight-saving time information that indicates the daylightsavings time corresponding to each region, and
said calculation means calculates the time at the current position corrected for daylightsaving time based on said daylight-saving time information.

4. The time output apparatus recited in claim 3, wherein
said holding means stores said daylight-saving time information in a storage means as a data table consisting of conversion data that converts said time difference information for daylightsaving time.

5. A time correction method comprising:
a current-position acquisition step wherein current-position information that indicates the current position is acquired;
a comparison step wherein the current-position information that indicates the current position obtained by the current-position acquisition means is compared against the positional information of the holding means which holds time difference information that indicates the time difference between the absolute standard time and the time at that position and thus the time difference information corresponding to the current position is obtained; and
a calculation step wherein the time at the current position is calculated based on the time difference corresponding to the current position and the standard time information that indicates the absolute standard time information.

6. The time correction method recited in claim 5, wherein
the time at said current position is corrected to daylight-saving time.
